(19) United States
(12) Patent Application Publication
(10) Pub. No.: US 2024/0198762 A1
(43) Pub. Date: Jun. 20, 2024

(54) TEMPERATURE ESTIMATION SYSTEM, TEMPERATURE ESTIMATION METHOD, AND STORAGE MEDIUM

(71) Applicant: TOYOTA JIDOSHA KABUSHIKI KAISHA, Toyota-shi (JP)

(72) Inventors: Shoji SAKAMOTO, Sunto-gun (JP); Kazumi TSUCHIYA, Gotemba-shi (JP); Makoto MATSUSHITA, Ichinomiya-shi (JP); Takeshi TAKEMOTO, Nagoya-shi (JP); Shunsuke SAGARA, Nisshin-shi (JP); Hideaki SHIRAISHI, Tokyo (JP)

(73) Assignee: TOYOTA JIDOSHA KABUSHIKI KAISHA, Toyota-shi (JP)

(21) Appl. No.: 18/483,798

(22) Filed: Oct. 10, 2023

(30) Foreign Application Priority Data
Dec. 16, 2022 (JP) 2022-201621

(51) Int. Cl. B60H 1/00; A01G 9/26; G01K 1/024; G01W 1/10

(52) U.S. Cl. CPC B60H 1/00878; A01G 9/26; G01K 1/024; G01W 1/10

(57) ABSTRACT

The temperature estimation system includes a vehicle cabin thermometer and an in-greenhouse temperature estimation unit. The vehicle cabin thermometer measures the temperature in the vehicle cabin of the vehicle parked in the vicinity of the vinyl house. The in-greenhouse temperature estimation unit includes a temperature estimation model based on a correlation between the temperature in the vehicle cabin and the temperature in the vinyl house. The in-greenhouse temperature estimation unit outputs the estimated temperature information in the vinyl house by inputting the temperature information acquired from the thermometer in the vehicle cabin to the temperature estimation model.

### CROSS-REFERENCE TO RELATED APPLICATION

This application claims priority to Japanese Patent Application No. 2022-201621 filed on Dec. 16, 2022, incorporated herein by reference in its entirety.

### BACKGROUND

### 1. Technical Field

The present disclosure relates to a temperature estimation system, a temperature estimation method, and a storage medium.

### 2. Description of Related Art

Japanese Unexamined Patent Application Publication (Translation of PCT Application) No. 2016-508366 (JP 2016-508366 A) below discloses a sensible temperature control system. In the sensible temperature control system, a temperature adjustment device is controlled based on, for example, a temperature inside a greenhouse that is measured by a thermometer, and the temperature in the greenhouse is adjusted.

In the related art described in JP 2016-508366 A, as described above, the temperature in the greenhouse is adjusted by the temperature adjustment device. This requires large capital investment.

It is also conceivable to suppress an increase in capital investment by, for example, opening and closing the door of the greenhouse by human power without using the temperature adjustment device. However, in this case, in order to consider the timing of adjusting the temperature in the greenhouse, a device for notifying the operator of the temperature in the greenhouse is needed. Capital investment is needed for this purpose.

### SUMMARY

In view of the above fact, an object of the present disclosure is to provide a temperature estimation system, a temperature estimation method, and a storage medium capable of notifying an outside of a greenhouse of a temperature in a greenhouse and suppressing an increase in capital investment therefor.

A temperature estimation system according to the present disclosure described in claim 1 includes: a temperature measurement unit that measures a temperature in a vehicle cabin of a vehicle parked in a vicinity of a greenhouse; and an in-greenhouse temperature estimation unit that includes a temperature estimation model that is based on a correlation between the temperature in the vehicle cabin and a temperature in the greenhouse, and that is able to output estimated temperature information in the greenhouse by inputting temperature information acquired from the temperature measurement unit to the temperature estimation model.

According to the present disclosure described in claim 1, the temperature in the vehicle cabin of the vehicle parked in the vicinity of the greenhouse is measured by the temperature measurement unit. Then, the in-greenhouse temperature estimation unit outputs the estimated temperature information in the greenhouse by inputting the temperature information acquired from the temperature measurement unit to the temperature estimation model that is based on the correlation between the temperature in the vehicle cabin and the temperature in the greenhouse.

Therefore, according to the present disclosure, it is possible to output the estimated temperature information in the greenhouse from the in-greenhouse temperature estimation unit to various devices without adding equipment to the greenhouse side.

The temperature estimation system according to the present disclosure described in claim 2 further includes, in the disclosure according to claim 1, a weather forecast information acquisition unit that is able to acquire weather forecast information. The in-greenhouse temperature estimation unit forecasts an expected time at which the temperature in the greenhouse becomes a predetermined temperature, by inputting a forecasted temperature at a predetermined time obtained from the weather forecast information to the temperature estimation model as the temperature in the vehicle cabin, and outputs the expected time as the estimated temperature information.

According to the present disclosure described in claim 2, the weather forecast information acquisition unit acquires the weather forecast information. Then, the in-greenhouse temperature estimation unit forecasts the expected time at which the temperature in the greenhouse becomes the predetermined temperature, by inputting the forecasted temperature at the predetermined time obtained from the weather forecast information to the temperature estimation model as the temperature in the vehicle cabin. Therefore, according to the present disclosure, a user of the greenhouse can perform various operations on the greenhouse based on the expected time at which the temperature in the greenhouse becomes the predetermined temperature.

The temperature estimation system according to the present disclosure described in claim 3 further includes, in the disclosure according to claim 1 or 2, a communication unit that is provided in the vehicle and that is able to transmit temperature information in the vehicle cabin acquired by the temperature measurement unit to a mobile terminal. The in-greenhouse temperature estimation unit is provided in the mobile terminal.

According to the present disclosure described in claim 3, the communication unit is provided in the vehicle. The communication unit transmits the temperature information in the vehicle cabin measured by the temperature measurement unit to the mobile terminal. On the other hand, the in-greenhouse temperature estimation unit is provided in the mobile terminal. The in-greenhouse temperature estimation unit outputs the estimated temperature information in the greenhouse based on the temperature information in the vehicle cabin that is transmitted from the vehicle side. Therefore, according to the present disclosure, it is possible to suppress complication of the configuration on the vehicle side in obtaining the estimated temperature information in the greenhouse.

In the temperature estimation system according to the present disclosure described in claim 4, in the disclosure according to claim 1 or 2: the in-greenhouse temperature estimation unit is provided in the vehicle; and the temperature estimation system further includes a communication unit that is provided in the vehicle and that is able to transmit the estimated temperature information to a mobile terminal.

According to the present disclosure described in claim 4, the in-greenhouse temperature estimation unit and the communication unit are provided in the vehicle. The estimated temperature information output from the in-greenhouse temperature estimation unit is transmitted to the mobile terminal via the communication unit. Therefore, according to the present disclosure, it is possible to suppress the complication of the configuration on the mobile terminal side in obtaining the estimated temperature information in the greenhouse.

A temperature estimation method according to the present disclosure described in claim 5 includes: measuring a temperature in a vehicle cabin of a vehicle parked in a vicinity of a greenhouse; and estimating a temperature in the greenhouse by inputting temperature information in the vehicle cabin to a temperature estimation model that is based on a correlation between the temperature in the vehicle cabin and the temperature in the greenhouse.

A storage medium according to the present disclosure described in claim 6 stores a temperature estimation program that causes at least one processor to: measure a temperature in a vehicle cabin of a vehicle parked in a vicinity of a greenhouse; and estimate a temperature in the greenhouse by inputting temperature information in the vehicle cabin to a temperature estimation model that is based on a correlation between the temperature in the vehicle cabin and the temperature in the greenhouse.

As described above, the temperature estimation system, the temperature estimation method, and the storage medium according to the present disclosure have an excellent effect that the temperature in the greenhouse can be notified to the outside of the greenhouse, and an increase in capital investment therefor can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an image diagram schematically showing a configuration of a temperature estimation system according to the present embodiment;

FIG. 2 is a block diagram illustrating a hardware configuration of a vehicle control device and a relationship with peripheral devices thereof in the temperature estimation system according to the present embodiment;

FIG. 3 is a block diagram illustrating a hardware configuration of a mobile terminal in the temperature estimation system according to the present embodiment;

FIG. 4 is a block diagram illustrating a functional configuration of the temperature estimation system according to the present embodiment;

FIG. 5 is a flow chart showing a flow of a process performed by the vehicle control device in the temperature estimation system according to the present embodiment; and

FIG. 6 is a flowchart illustrating a flow of processing performed by the mobile terminal in the temperature estimation system according to the present embodiment.

### DETAILED DESCRIPTION OF EMBODIMENTS

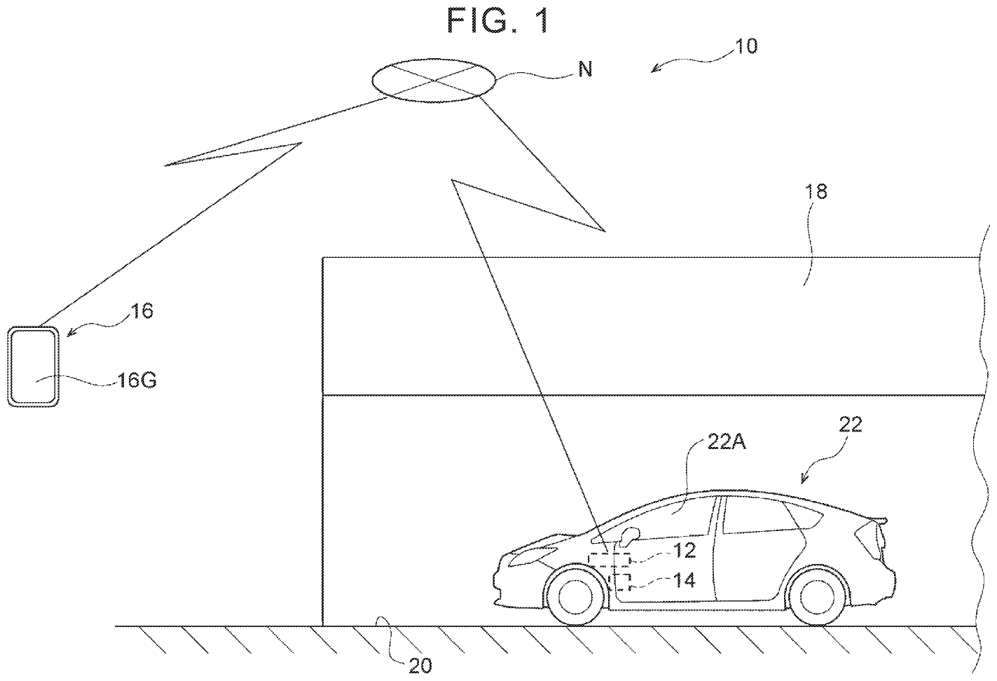

Hereinafter, an example of an embodiment of a temperature estimation system according to the present disclosure will be described with reference to FIGS. 1 to 6. As illustrated in FIG. 1, the “temperature estimation system 10” according to the present embodiment includes a vehicle control device 12, a “vehicle cabin thermometer 14” as a temperature measurement unit, and a “mobile terminal 16”.

The vehicle control device 12 is mounted on a “vehicle 22” parked in a parking space 20 provided adjacent to a “vinyl house 18” which is an example of a greenhouse.

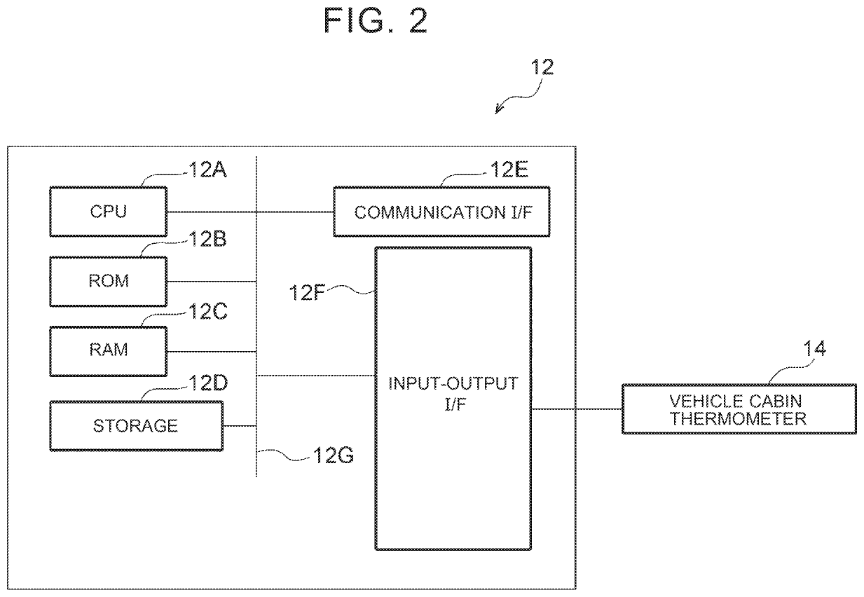

As illustrated in FIG. 2, the vehicle control device 12 includes a Central Processing Unit (CPU) 12A, Read Only Memory (ROM) 12B, Random Access Memory (RAM) 12C, a storage 12D, a communication Interface (I/F) 12E, and an input/output I/F 12F as processors. CPU 12A, ROM 12B, RAM 12C, the storage 12D, the communication I/F 12E, and the input/output I/F 12F are communicably connected to each other via a bus 12G.

CPU 12A is a central processing unit and can execute various programs. Specifically, CPU 12A can read a program from ROM 12B and execute the program using RAM 12C as a working area. Then, the executable program stored in ROM 12B is read and executed by CPU 12A. As a result, the vehicle control device 12 can perform various functions as described later. The ROM 12B is an example of a storage medium.

More specifically, ROM 12B stores various programs and various data. On the other hand, RAM 12C can temporarily store programs/data as a working area.

Storage 12D includes Hard Disk Drive (HDD) or Solid State Drive (SSD). The storage 12D can store various programs including an operating system and various types of data. As will be described later, the storage 12D is capable of storing the measured value of the vehicle cabin thermometer 14 and various types of spec information of the vehicle 22.

The communication I/F 12E is an interface used to connect the vehicle-control device 12 to the network N. For the interface, for example, communication standards such as Ethernet (registered trademark), fiber-distributed data interface (FDDI), and Wi-Fi (registered trademark) are used. The communication I/F 12E may include a radio device. The communication I/F 12E can transmit and receive various types of data to and from the mobile terminal 16 by communicating with the mobile terminal 16 via the network N. The various types of data acquired from the mobile terminal 16 are stored in the storage 12D.

The input/output I/F 12F is an interface for the vehicle control device 12 to communicate with the respective devices mounted on the vehicle 22. The vehicle control device 12 is connected to various devices described later via an input/output I/F 12F so as to be able to communicate with each other. These devices may be directly connected to the bus 12G.

The device connected to the input/output I/F 12F of the vehicle control device 12 is a vehicle cabin thermometer 14. The vehicle cabin thermometer 14 is capable of measuring the temperature in the “vehicle cabin 22A” of the vehicle 22, and transmits a temperature signal based on the temperature to the vehicle control device 12. The storage 12D stores time-series data of the air temperature of the vehicle cabin 22A.

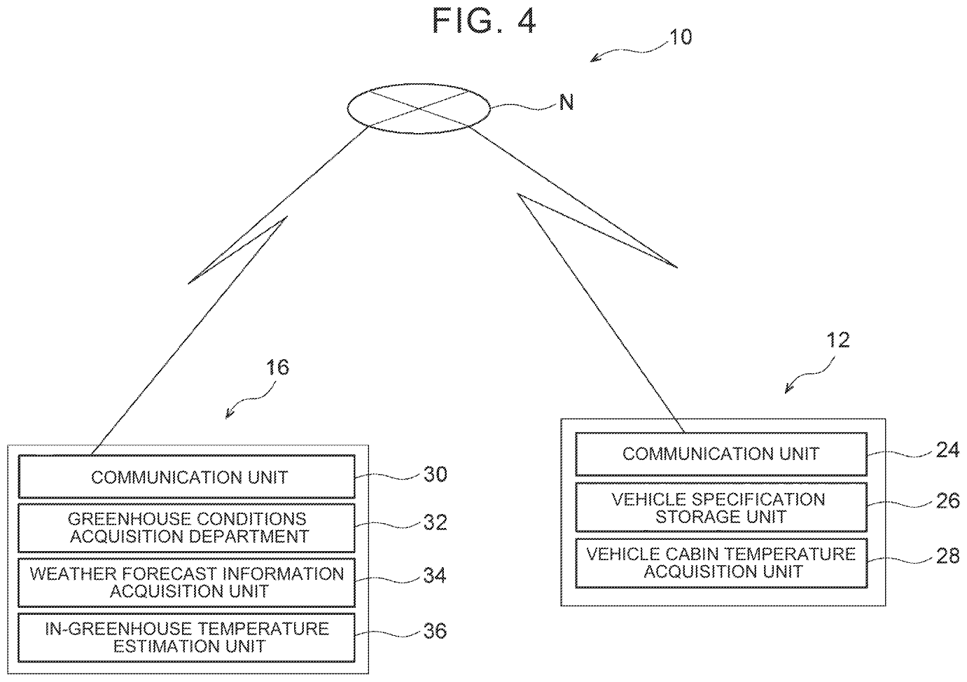

Next, a functional configuration of the vehicle control device 12 will be described with reference to FIG. 4. CPU 12A reads the executable program stored in ROM 12B and executes the executable program by the vehicle control device 12. Thus, the vehicle control device 12 functions as an aggregate of the communication unit 24, the vehicle specification storage unit 26, and the vehicle cabin temperature acquisition unit 28.

The communication unit 24 is capable of transmitting and receiving various kinds of information to and from the mobile terminal 16 via the network N.

The vehicle specification storage unit 26 stores vehicle specification information related to the specification of the vehicle 22. Specifically, the vehicle specification storage unit 26 stores the volume of the vehicle cabin 22A, the area of the opening of the vehicle 22, that is, the area of the front window, the area of the rear window, and the sum of the areas of the side windows. When the communication unit 24 receives the request signal from the mobile terminal 16, the vehicle specification storage unit 26 transmits the vehicle specification information of the vehicle 22 to the mobile terminal 16 via the communication unit 24.

The vehicle cabin temperature acquisition unit 28 acquires temperature information measured by the vehicle cabin thermometer 14, and stores time-series data of the air temperature in the vehicle cabin 22A. When the communication unit 24 receives a request signal from the mobile terminal 16, the vehicle cabin temperature acquisition unit 28 transmits time-series data of the air temperature in the vehicle cabin 22A to the mobile terminal 16 via the communication unit 24.

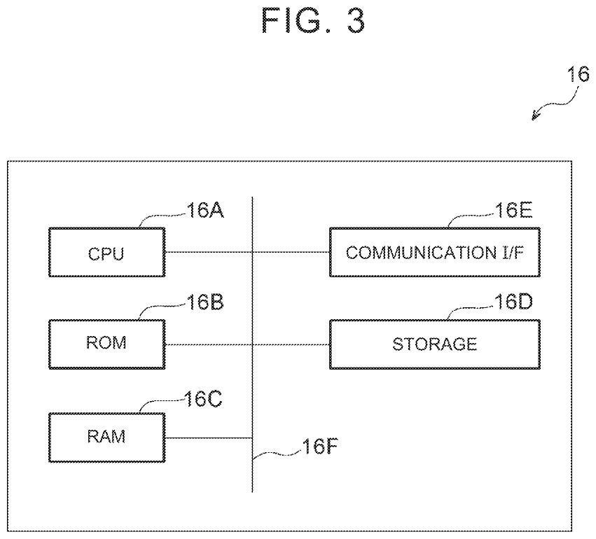

Next, the configuration of the mobile terminal 16 will be described with reference to FIG. 3. The mobile terminal 16 is a terminal used by a user of the vinyl house 18 and the vehicles 22, and includes a CPU 16A, ROM 16B, RAM 16C, a storage 16D, and a communication I/F 16E as a processor. CPU 16A, ROM 16B, RAM 16C, the storage 16D, and the communication I/F 16E are communicably connected to each other via a bus 16F. It should be noted that CPU 16A, ROM 16B, RAM 16C storage 16D and the communication I/F 16E have basically the same functions as those constituting the above-described vehicle control device 12.

Storage 16D also include embedded Multi Media Card (eMMC) or Universal Flash Storage (UFS). The storage 16D can store various programs and various data such as a temperature-estimation model, which will be described later. Then, the executable program stored in ROM 16B is read and executed by CPU 16A, so that the mobile terminal 16 can perform various functions.

Specifically, predetermined application software (hereinafter referred to as an application) is installed in the mobile terminal 16. When the application is activated by the user of the mobile terminal 16, the mobile terminal 16 functions as an aggregate of the communication unit 30, the greenhouse condition acquisition unit 32, the weather forecast information acquisition unit 34, and the in-greenhouse temperature estimation unit 36, as shown in FIG. 4.

The communication unit 30 is capable of transmitting and receiving various kinds of information to and from the vehicle control device 12 and a data server (not shown) via the network N.

The greenhouse condition acquisition unit 32 is capable of acquiring greenhouse specification information related to the specification of the vinyl house 18 based on the operation of the mobile terminal 16 by the user. Specifically, the greenhouse condition acquisition unit 32 acquires greenhouse specification information such as the volume of the vinyl house 18 and the material of the material constituting the vinyl house 18 (vinyl chloride, polyolefin film, or the like) by displaying a predetermined operation screen to the user by input from the user. The greenhouse condition acquisition unit 32 can transmit the acquired greenhouse specification information to the in-greenhouse temperature estimation unit 36.

The weather forecast information acquisition unit 34 can acquire weather forecast information from the data server. The weather forecast information acquisition unit 34 can transmit the acquired weather forecast information to the in-greenhouse temperature estimation unit 36.

The in-greenhouse temperature estimation unit 36 can acquire vehicle specification information of the vehicle 22 from the vehicle specification storage unit 26 by transmitting a request signal to the vehicle specification storage unit 26 via the communication unit 30. In addition, the in-greenhouse temperature estimation unit 36 transmits a request signal to the vehicle cabin temperature acquisition unit 28 via the communication unit 30, so that time-series data of the air temperature in the vehicle cabin 22A can be acquired from the vehicle cabin temperature acquisition unit 28.

Then, the in-greenhouse temperature estimation unit 36 inputs various kinds of information including the greenhouse specification information acquired from the greenhouse condition acquisition unit 32, the vehicle specification information acquired from the vehicle specification storage unit 26, and the time-series data of the air temperature in the vehicle cabin 22A acquired from the vehicle cabin temperature acquisition unit 28 to the temperature estimation model. Accordingly, the in-greenhouse temperature estimation unit 36 outputs the current estimated temperature in the vinyl house 18 as the estimated temperature information.

The temperature estimation model is a machine-learned model. As an example, in a plurality of combinations of various vinyl houses and various vehicles parked in the vicinity of the vinyl house, a set of greenhouse specification information of the vinyl house, vehicle specification information of the vehicle, time-series data of the air temperature in the vehicle cabin, and time-series data of the air temperature in the vinyl house is used as teacher data. Learning is performed in accordance with known machine learning techniques, such as recurrent neural networks.

Further, the in-greenhouse temperature estimation unit 36 receives the time-series data of the expected air temperature of the area where the vinyl house 18 is installed at the predetermined time acquired from the weather forecast information acquisition unit 34 as time-series data of the air temperature in the vehicle cabin 22A. Thereby, the in-greenhouse temperature estimation unit 36 predicts a scheduled time at which the temperature in the vinyl house 18 becomes a predetermined temperature. The in-greenhouse temperature estimation unit 36 can output the scheduled time as estimated temperature information.

Note that the in-greenhouse temperature estimation unit 36 displays the estimated temperature and the scheduled time outputted from the temperature estimation model on the display unit 16G of the mobile terminal 16.

### OPERATION AND EFFECT OF THE PRESENT EMBODIMENT

Next, operations and effects of the present embodiment will be described.

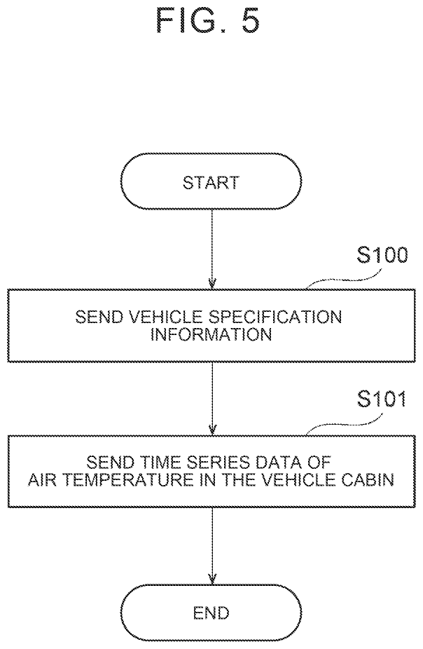

Hereinafter, an example of a control flow of the vehicle control device 12 will be described mainly with reference to a flowchart illustrated in FIG. 5.

When this control flow is started, in $100, CPU 12A of the vehicle control device 12 transmits the vehicle specification information of the vehicle 22 to the mobile terminal 16 in response to a request signal from the mobile terminal 16.

In S101, CPU 12A transmits the time series of the air temperature in the vehicle cabin 22A to the mobile terminal 16 in response to a request signal from the mobile terminal 16. CPU 16A terminates the control flow.

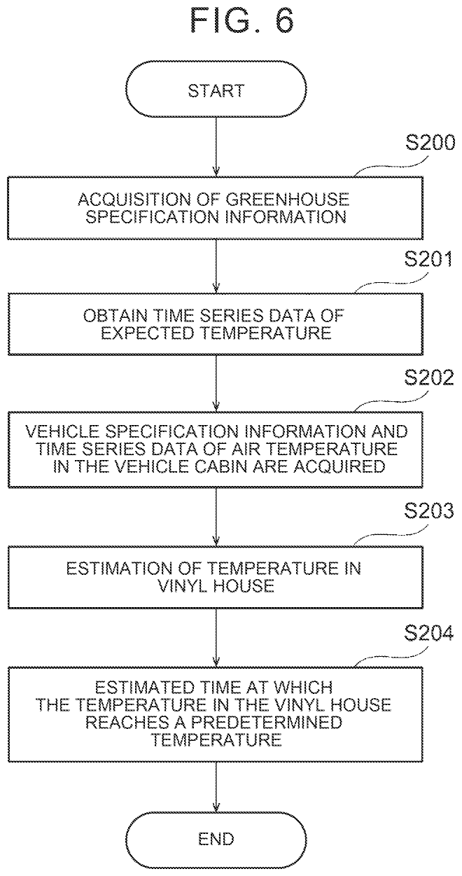

Next, an example of a control flow of the mobile terminal 16 will be described mainly using the flowchart shown in FIG. 6.

In S200, CPU 16A displays a predetermined operating window for the user. CPU 16A obtains greenhouse specifications of the vinyl house 18.

In S201, CPU 16A acquires, from the data server, time-series data of the expected air temperature of the area where the vinyl house 18 is installed.

In S202, CPU 16A acquires, from the vehicle control device 12, the vehicle specification information and the time-series data of the air temperature in the vehicle cabin 22A.

In S203, CPU 16A inputs the greenhouse specification information, the vehicle specification information, and the time series data of the air temperature in the vehicle cabin 22A into the temperature estimation model. CPU 16A outputs the current estimated temperature in the vinyl house 18 as estimated temperature information.

In S204, CPU 16A inputs, into the temperature estimation model, the greenhouse specification information, the vehicle specification information, and the time-series data of the expected air temperature of the area where the vinyl house 18 is installed. CPU 16A predicts a scheduled time at which the temperature in the vinyl house 18 reaches a predetermined temperature. CPU 16A terminates the control flow.

Therefore, in the present embodiment, the estimated temperature information in the vinyl house 18 can be output from the in-greenhouse temperature estimation unit 36 to various devices such as the mobile terminal 16 without adding equipment to the vinyl house 18.

Further, in the present embodiment, the in-greenhouse temperature estimation unit 36 inputs the expected temperature at a predetermined time, which is obtained from the weather forecast information, as the temperature in the vehicle cabin 22A to the temperature estimation model. Thereby, the in-greenhouse temperature estimation unit 36 predicts a scheduled time at which the temperature in the vinyl house 18 becomes a predetermined temperature. Therefore, in the present embodiment, the user of the vinyl house 18 can perform various operations on the vinyl house 18 based on the scheduled time at which the temperature in the vinyl house 18 becomes a predetermined temperature.

In addition, in the present embodiment, the mobile terminal 16 is provided with the in-greenhouse temperature estimation unit 36 by installing a predetermined application in the mobile terminal 16. Therefore, in the present embodiment, when the estimated temperature information in the vinyl house 18 is obtained, it is possible to suppress complication of the configuration of the vehicle 22 side.

As described above, in the present embodiment, the temperature inside the vinyl house 18 can be notified to the outside of the vinyl house 18. An increase in capital investment for this purpose can be suppressed.

### MODIFIED EXAMPLES

Next, a modification of the above-described embodiment will be described.

In this modification, although the configuration is basically the same as that of the above-described embodiment, the weather forecast information acquisition unit 34 and the in-greenhouse temperature estimation unit 36 are incorporated in the functional configuration of the vehicle control device 12.

According to such a configuration, the estimated temperature information of the vinyl house 18 is transmitted from the vehicle control device 12 to the mobile terminal 16. Therefore, when obtaining the estimated temperature information in the vinyl house 18, it is possible to suppress the complication of the functional configuration of the mobile terminal 16.

What is claimed is:

1. A temperature estimation system comprising:
a temperature measurement unit that measures a temperature in a vehicle cabin of a vehicle parked in a vicinity of a greenhouse; and
an in-greenhouse temperature estimation unit that includes a temperature estimation model that is based on a correlation between the temperature in the vehicle cabin and a temperature in the greenhouse, and that is able to output estimated temperature information in the greenhouse by inputting temperature information acquired from the temperature measurement unit to the temperature estimation model.

2. The temperature estimation system according to claim 1, further comprising a weather forecast information acquisition unit that is able to acquire weather forecast information, wherein the in-greenhouse temperature estimation unit
forecasts an expected time at which the temperature in the greenhouse becomes a predetermined temperature, by inputting a forecasted temperature at a predetermined time obtained from the weather forecast information to the temperature estimation model as the temperature in the vehicle cabin, and
outputs the expected time as the estimated temperature information.

3. The temperature estimation system according to claim 1, further comprising a communication unit that is provided in the vehicle and that is able to transmit temperature information in the vehicle cabin acquired by the temperature measurement unit to a mobile terminal, wherein the in-greenhouse temperature estimation unit is provided in the mobile terminal.

4. The temperature estimation system according to claim 1, wherein:
the in-greenhouse temperature estimation unit is provided in the vehicle; and
the temperature estimation system further includes a communication unit that is provided in the vehicle and that is able to transmit the estimated temperature information to a mobile terminal.

5. A temperature estimation method comprising:
measuring a temperature in a vehicle cabin of a vehicle parked in a vicinity of a greenhouse; and
estimating a temperature in the greenhouse by inputting temperature information in the vehicle cabin to a temperature estimation model that is based on a correlation between the temperature in the vehicle cabin and the temperature in the greenhouse.

6. A non-transitory storage medium storing a temperature estimation program that causes at least one processor to:
measure a temperature in a vehicle cabin of a vehicle parked in a vicinity of a greenhouse; and
estimate a temperature in the greenhouse by inputting temperature information in the vehicle cabin to a temperature estimation model that is based on a correlation between the temperature in the vehicle cabin and the temperature in the greenhouse.
